(19) United States
(12) Patent Application Publication
(10) Pub. No.: US 2008/0078508 A1
(43) Pub. Date: Apr. 3, 2008

(54) Window blind

(76) Inventor: Jill Elaine Guisti, Bellingham, MA (US)

Correspondence Address: KRIEGSMAN & KRIEGSMAN, 30 TURNPIKE ROAD, SUITE 9, SOUTHBOROUGH, MA, 01772, US

(21) Appl. No.: 11/903,391

(22) Filed: Sep. 21, 2007

Related U.S. Application Data
(60) Provisional application No. 60/848,128, filed on Sep. 29, 2006.

(51) Int. Cl. E06B 9/26

(52) U.S. Cl. 160/166.1

(57) ABSTRACT

A window blind includes an elongated head rail, a pair of ladder-shaped cords which extends vertically down from the head rail, and a plurality of individual slats which are supported by the pair of cords. A pair of stopper-shaped mounts protrude out from opposite ends of the head rail. At least one of the mounts is fixedly connected to the head rail by a spring. In order to mount the window blind within a window frame, a compressive force is applied to the spring which draws the pair of mounts in towards one another to the extent necessary so that the window blind fits within the window frame. Once the window blind is properly positioned within the window frame, the compressive force is withdrawn which causes the pair of mounts to resiliently spread apart and contact the window frame with such pressure that the window blind remains securely installed therewithin.

### CROSS-REFERENCE TO RELATED APPLICATIONS

The present application claims the benefit under 35 U.S.C. 119(e) of U.S. provisional Patent Application Ser. No. 60/848,128, filed Sep. 29, 2006, the disclosure of which is incorporated herein by reference.

### BACKGROUND OF THE INVENTION

The present invention relates generally to the treatment of windows and more particularly to window blinds.

Blinds are well known in the art and are widely used to cover the interior side of a glass window or door. Used in this capacity, blinds serve to both provide privacy and reduce the amount of sunlight and resultant heat that enters into a room, which is highly desirable.

A mini-blind is one type of blind that is well known in the art. Referring now to FIG. 1, there is shown one well known version of a mini-blind. As can be seen, blind 11 comprises a horizontal head rail 13 that is generally U-shaped in lateral cross-section, head rail 13 being constructed of a rigid metallic material. A pair of spaced apart, ladder-type cords 15-1 and 15-2 extend vertically down from head rail 13. A plurality of horizontally disposed vinyl slats 17 (also commonly referred to in the art as a vanes) are mounted on the pair of cords 15, each slat 17 being supported on a corresponding rung of each ladder-type cord 15.

A wand 19 is coupled to cords 15 and can be used to rotate each slat 17 about its longitudinal axis. Specifically, by rotating wand 19, slats 17 can be configured between an open position (i.e., with the top and bottom surface of each slat 17 horizontally disposed) and a closed position (i.e., with the top and bottom surface of each slat 17 vertically disposed). Furthermore, a lift cord 21 is coupled to cords 15 and can be used to either (i) raise slats 17 upward and into a tight, nested relationship or (ii) lower slats 17 down in a spaced apart relationship (as shown).

A pair of mounting brackets 23-1 and 23-2 are typically used to fixedly mount mini-blind 11 within a window frame. Each bracket 23 is generally C-shaped in transverse cross-section and is designed to be fixedly secured to the inner surface of a window frame using one or more screws 25. With brackets 23 fixed in place within a window frame, head rail 13 is slidably mounted within the notch defined by each bracket 23. In this manner, brackets 23 serve to support head 13 in place within the window frame.

A decorative valence 27 is often attached to head rail 13 using a pair of plastic clips 29, each clip 29 being designed to snap-mount on head rail 13. As can be appreciated, valence 27 serves, among other things, to disguise the mounting brackets 23 and thereby render blind 11 more aesthetically pleasing.

Although well known and widely used in the art, it has been found that the use of mounting brackets 23 to install a blind within a window frame introduces a number of notable drawbacks.

As a first drawback, it has been found that the process of installing brackets 23 is a rather difficult, labor-intensive and time-consuming undertaking. In particular, many consumers do not possess the skill, dexterity and/or instruments (e.g., a drill) to properly mount brackets 23 within a window frame (e.g., in a level manner).

As a second drawback, it has been found that certain consumers are hesitant to drill screws into the molding of a window frame. Furthermore, in certain circumstances, window frames are made of metal and, as a result, are incapable of having screws driven therein.

### SUMMARY OF THE INVENTION

It is an object of the present invention to provide a new and improved window blind.

It is another object of the present invention to provide a window blind which can be easily and securely installed within a window frame.

It is yet another object of the present invention to provide a window blind which can be installed within a window frame without permanently damaging the frame in any manner.

It is still another object of the present invention to provide a window blind which has a limited number of parts, is inexpensive to manufacture and is easy to use.

Accordingly, there is provided a window blind comprising (a) an elongated head rail having a first end, a second end and a longitudinal axis, (b) a plurality of individual slats coupled to the head rail, and (c) first and second opposing mounts fixedly coupled to the head rail, the first mount at least partially protruding out beyond the first end of the head rail and the second mount at least partially protruding out beyond the second end of the head rail.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a partially exploded, front perspective view of a window blind that is well known in the art;

FIG. 2 is a front perspective view of one embodiment of a window blind that is constructed according to the teachings of the present invention;

FIG. 3 is an enlarged, fragmentary, top plan view of the window blind shown in FIG. 2; and

FIG. 4 is an enlarged, fragmentary, top plan view of another embodiment of a window blind constructed according to the teachings of the present invention.

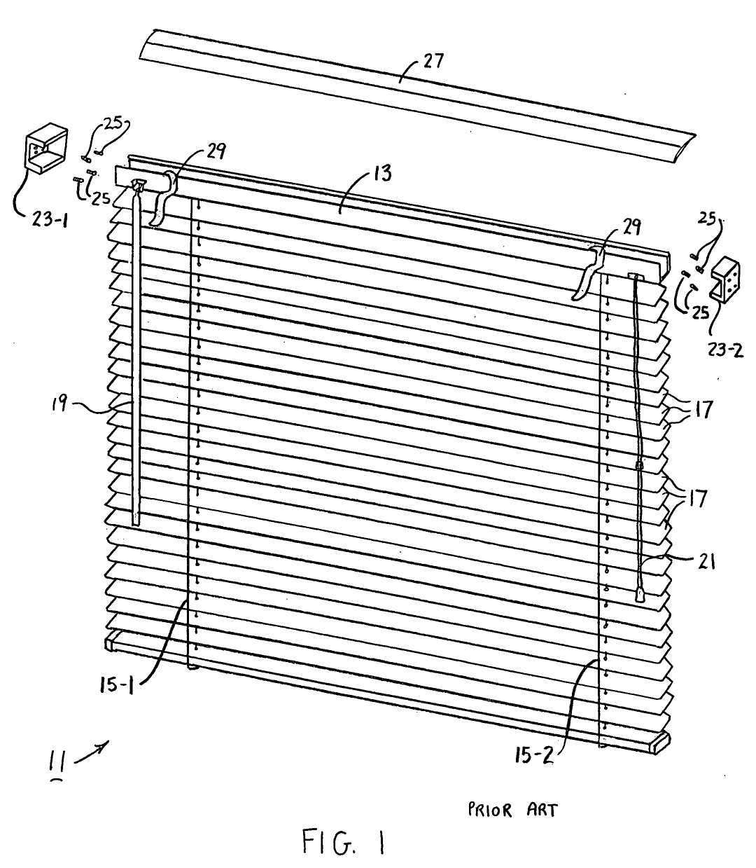

### DETAILED DESCRIPTION OF THE PREFERRED EMBODIMENT

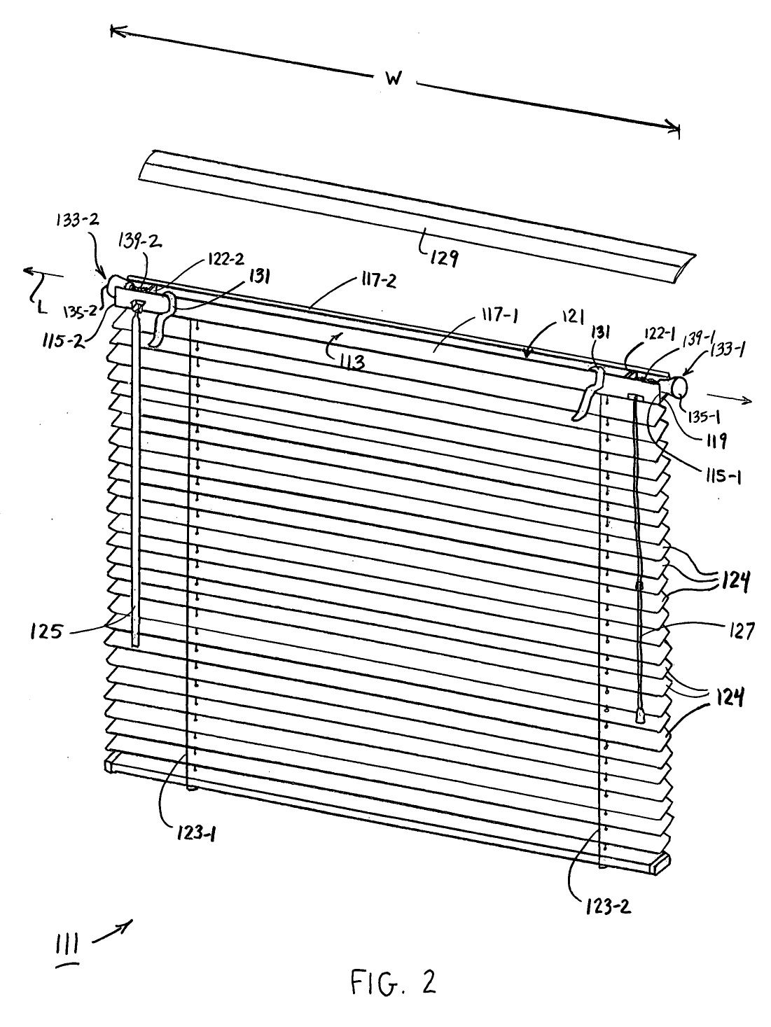

Referring now to FIG. 2, there is shown a front perspective view of a first embodiment of a window blind that is constructed according to the teachings of the present invention and identified generally by reference numeral 111. As will be described further below, blind 111 can be easily installed within a window frame, which is a principal object of the present invention.

Blind 111 is similar to blind 11 in that blind 111 includes an elongated, horizontal head rail 113 that includes a first end 115-1, a second end 115-2 and a longitudinal axis L, head rail 113 being preferably constructed of a rigid and durable material, such as metal or hardened plastic. Head rail 113 is generally U-shaped in lateral cross-section and includes a pair of spaced apart, vertical sidewalls 117-1 and 117-2 and a horizontal bottom wall 119 which together define an elongated channel 121 that is generally square-shaped in transverse cross-section.

Head rail 113 (also referred to herein as top rail 113) differs from head rail 13 in that head rail 113 additionally comprises a pair of transverse interior walls 122-1 and 122-2 which are located within elongated channel 121. Each interior wall 122 is represented herein as being in the form of a thin, square plate which extends vertically up bottom wall 119 and across channel 121 from sidewall 117-1 to sidewall 117-2, with interior wall 122-1 being spaced slightly in from first end 115-1 and interior wall 122-2 being spaced slightly in from second end 115-2.

Blind 111 is also similar to blind 11 in that blind 111 includes a pair of spaced apart, ladder-type cords 123-1 and 123-2 that extend vertically down from top rail 113. Blind 111 additionally includes a plurality of horizontally disposed vinyl slats 124 that are mounted on the pair of cords 123, each slat 124 being supported on a corresponding rung (not shown) of each ladder-type cord 123.

In use, manipulation of slats 124 is accomplished in the same manner as in blind 11. Specifically, a wand 125 is coupled to cords 123 (preferably within channel 121 for aesthetic purposes) and can be used to pivot each slat 124 about its longitudinal axis. In particular, by rotating wand 125, slats 124 can be configured between an open position (i.e., with the top and bottom surface of each slat 124 horizontally disposed) and a closed position (i.e., with the top and bottom surface of each slat 124 vertically disposed). Furthermore, a lift cord 127 is coupled to cords 123 and can be used to either (i) raise slats 124 upward and into a tight, nested relationship or (ii) lower slats 124 down in a spaced apart relationship (as shown).

Blind 111 is additionally similar to blind 11 in that blind 111 includes a decorative valence 129 that can be affixed to head rail 113 using a pair of plastic clips 131, each clip 131 being designed to snap-mount on sidewall 117-1 of head rail 113 (as shown in FIG. 2). As can be appreciated, valence 129 serves, among other things, to disguise the majority of head rail 113 and thereby render blind 111 more aesthetically pleasing.

Window blinds 11 and 111 differ principally in their means of installation within a window frame. As will be described in detail below, blind 111 is designed to be easily installed and/or removed from a window frame using spring-biased, friction and pressure mount means.

Specifically, window blind 111 comprises a pair of opposing mounts 133-1 and 133-2 which are fixedly connected to head rail 113, each mount 133 including an enlarged, substantially flat contact surface 135 at its free end. As seen most clearly in FIG. 3, mount 133-1 is naturally disposed (i.e., in the absence of any outside force thereon) to at least partially protrude out from head rail 113 in such a manner so that its contact surface 135-1 extends substantially beyond first end 115-1. Similarly, mount 133-2 is naturally disposed to at least partially protrude out from head rail 113 in such a manner so that its contact surface 135-2 extends substantially beyond second end 115-2.

Preferably, each mount 133 is constructed of a material which has a high coefficient of friction, such as rubber. In this manner, outwardly protruding mounts 133 can be used to abut against and frictionally engage the interior surface of a window frame to retain blind 111 installed therein, as will be described in greater detail below.

As seen most clearly in FIG. 3, each mount 133 is represented herein as being in the form of a stopper (i.e, a plug or cap) which includes an open first end 137-1 and an enclosed second end 137-2, with contact surface 135 being formed on the outer surface of enclosed second end 137-2. Each mount 133 is also hollowed out along a portion of its length so as to define a longitudinal bore (not shown) which is externally accessible through open first end 137-1.

Mount 133-1 is connected to interior wall 122-1 by a compression spring 139-1. Similarly, mount 133-2 is connected to interior wall 122-2 by a compression spring 139-2. Specifically, one end of each compression spring 139 is fixedly connected to its corresponding interior wall 122 using any suitable attachment means (e.g., welding), the remainder of spring 139 extending orthogonally out from interior wall 122. The free end of each compression spring 139 is fittingly inserted into the longitudinal bore of its corresponding mount 133 through open end 137-1. Preferably, the inner surface of each mount 133 (i.e., the surface which immediately defines the longitudinal bore) is provided with means for engaging spring 139 (e.g., using one or more gripping ribs or grooves) in order to retain mount 133 on spring 139.

As seen most clearly in FIG. 3, each compression spring 139 enables its corresponding mount 133 to be linearly displaced within channel 121 along a path A which is substantially parallel to the longitudinal axis L of head rail 113. For example, upon the application of substantial inward force on enclosed second end 137-2, mount 133-1 can be displaced linearly inward towards mount 133-2 such that its contact surface 135-1 is drawn closer to end 115-1 of head rail 113. Furthermore, once the force applied to second end 137-2 is released, spring 139-1 displaces mount 133-1 resiliently outward and back to its original position (i.e., with contact surface 135-1 spaced further away from end 115-1 of head rail 113).

In use, blind 111 may be installed in a window frame in the following manner. Specifically, contact surface 135-1 of mount 133-1 is positioned against the interior surface of the desired window frame in the preferred location in which blind 111 is to be mounted, the remainder of blind 111 being temporarily disposed outside the frame. Head rail 113 is then urged in the direction towards contact surface 135-1 of mount 133-1 which, in turn, causes spring 139-1 to compress, thereby reducing the overall width W of window blind 111 (i.e., reducing the distance from contact surface 135-1 to contact surface 135-2). While maintaining spring 139-1 in its compressed state, mount 133-2 is similarly positioned in place against the opposing interior surface of the window frame. If necessary, a secondary inward force may be applied to contact surface 135-2 of mount 133-2 to the degree necessary so that window blind 111 can fit within the desired window frame (i.e., such that the overall width W of window blind 111 is less than the overall width of the window frame in which it is to be installed).

With mount 135-2 properly positioned within window frame, the primary compression force applied to spring 139-1 is released which, in turn, causes spring 139-1 to displace mount 133-1 resiliently outward such that contact surface 135-1 on mount 133-1 presses firmly against the window frame. In this manner, it is to be understood that springs 139-1 and 139-2 serve to continuously urge contact surfaces 135-1 and 135-2, respectively, firmly against opposing sides of the window frame with such pressure and frictional engagement that blind 111 remains securely installed.

Furthermore, it is to be understood that an installed window blind 111 can be similarly removed from a window frame by applying a compressive force onto one or both springs 139 to degree necessary so that the overall width W of window blind 111 less than the overall width of the window frame in which it is installed.

The ability to install window blind 111 using the spring-mounting means described in detail above introduces a couple notable advantages.

As a first advantage, window blind 111 can be installed without the use of any expensive and/or mechanically complex tools (e.g., drills, screwdrivers, etc.). As a result, window blind 111 is significantly easier to install than traditional window blinds 11, which is a principal object of the present invention.

As a second advantage, because window blind 111 does not permanently damage the window frame in which it is mounted, it is anticipated that a single window blind 111 be reused in a number of different environments. As a result, it is envisioned that window blind 111 has a particular usefulness for consumers who frequently change their place of residence (e.g., students).

It is to be understood that structural modifications to window blind 111 could be made without departing from the spirit of the present invention.

As an example, it should be noted that both mounts 133 need not be independently spring mounted on head rail 113. Rather, it is to be understood that one of mounts 133 could be held fixed in place in relation to head rail 113 (i.e., connected to interior wall 122 by a cylindrical post rather than a compression spring 139) without departing from the spirit of the present invention. In addition, it is to be understood that both mounts 133 may be coupled together by a single, spring-biased tube (or similar item) that is located within channel 121 and extends nearly the entire length of head rail 113 without departing from the spirit of the present invention.

As another example, It should also be noted that mounts 133 are not limited to the stopper design described above. Rather, it is to be understood that each mount 133 could be formed in other suitable shapes (e.g., a substantially flat plate or block) without departing from the spirit of the present invention.

As yet another example, it should be noted that blind 111 need not be limited to the use of springs 139 to displace each mount 133 along a linear path relative to head rail 113. Rather, it is to be understood that alternative means for linearly displacing one or both of stoppers 123 relative to head rail 113 could be provided without departing from the spirit of the present invention.

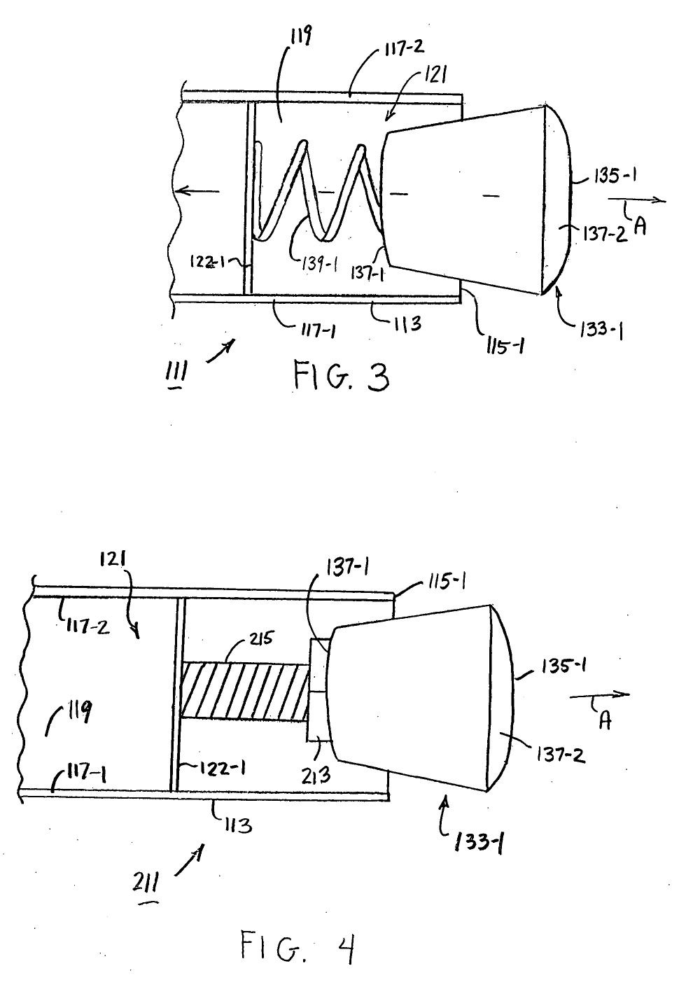

For example, referring now to FIG. 4, there is shown another embodiment of a window blind that is constructed according to the teachings of the present invention and identified generally by reference numeral 211. As can be seen, window blind 211 differs from window blind 111 in that contact surface 135-1 of mount 133-1 is designed for linear displacement towards and away from first end 115-1 of head rail 133 using threaded means. Specifically, a threaded nut 213 is fixedly mounted on mount 133-1 at its open end 137-1. In turn, nut 213 is axially mounted on a threaded stem 215 (e.g., a bolt or screw) that is permanently affixed at one end onto interior wall 122-1, the free end of stem 215 extending orthogonally away from wall 122-1 in the direction towards first end 115-1. Accordingly, in use, nut 213 can be rotated about stem 215 (e.g., by hand or using a wrench) in order to linearly drive mount 133-1 into contact against (or away from) a window frame.

The embodiments shown in the present invention are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A window blind, comprising:
(a) an elongated head rail having a first end, a second end and a longitudinal axis,
(b) a plurality of individual slats coupled to the head rail, and
(c) first and second opposing mounts fixedly coupled to the head rail, the first mount at least partially protruding out beyond the first end of the head rail and the second mount at least partially protruding out beyond the second end of the head rail.

2. The window blind as claimed in claim 1 wherein the first mount is adapted for linear displacement relative to the second mount.

3. The window blind as claimed in claim 2 wherein the first mount is adapted for linear displacement relative to the second mount along a path which is substantially parallel to the longitudinal axis of the head rail.

4. The window blind as claimed in claim 2 wherein the first mount is resiliently urged away from the second mount.

5. The window blind as claimed in claim 3 wherein the first mount is fixedly connected to the head rail by a compression spring.

6. The window blind as claimed in claim 3 wherein the first mount is fixedly connected to the head rail by an elongated threaded stem.

7. The window blind as claimed in claim 6 wherein the first mount is axially mounted on the elongated threaded stem.

8. The window blind as claimed in claim 5 wherein the first mount is in the form of a partially hollowed stopper which includes an open first end and an enclosed second end.

9. The window blind as claimed in claim 8 wherein one end of the compression spring is inserted into the stopper through its open first end.

10. The window blind as claimed in claim 3 wherein the head rail comprises:
(a) a horizontal bottom wall, and
(b) a pair of upstanding sidewalls,
(c) wherein the bottom wall and the pair of upstanding sidewalls together at least partially define an elongated channel.

11. The window blind as claimed in claim 10 wherein each mount is at least partially disposed within the channel defined by the head rail.

12. The window blind as claimed in claim 11 wherein the head rail further comprises first and second transverse interior walls located within the elongated channel, the first interior wall being spaced in from the first end of the head rail and the second interior wall being spaced in from the second end of the head rail.

13. The window blind as claimed in claim 12 wherein the first mount is fixedly coupled to the first interior wall and the second mount is fixedly coupled to the second interior wall.

14. The window blind as claimed in claim 1 further comprising a ladder-shaped cord which extends vertically down from the head rail, the ladder-shaped cord supporting each of the plurality of slats.
